(19) United States
(12) Patent Application Publication
(10) Pub. No.: US 2022/0245710 A1
(43) Pub. Date: Aug. 4, 2022

(54) SYSTEM AND METHOD FOR DETERMINING A PERSONALIZED ITEM RECOMMENDATION STRATEGY FOR AN ANCHOR ITEM

(71) Applicant: Walmart Apollo, LLC, Bentonville, AR (US)

(72) Inventors: Anant Maheshwari, Sunnyvale, CA (US); Sinduja Subramaniam, San Jose, CA (US); Divya Chaganti, Santa Clara, CA (US); Evren Korpeoglu, San Jose, CA (US); Sushant Kumar, Sunnyvale, CA (US); Kannan Achan, Saratoga, CA (US)

(73) Assignee: Walmart Apollo, LLC, Bentonville, AR (US)

(21) Appl. No.: 17/589,502

(22) Filed: Jan. 31, 2022

Related U.S. Application Data
(63) Continuation-in-part of application No. 17/163,216, filed on Jan. 29, 2021.

(51) Int. Cl. G06Q 30/06; G06Q 30/02

(52) U.S. Cl. CPC G06Q 30/0631; G06Q 30/0207; G06Q 30/0627

(57) ABSTRACT

A method of obtaining item recommendations associated with an anchor item chosen by a user via a user interface executed on a user device of the user. The method further can include determining an anchor label for the anchor item. In a number of embodiments, the anchor label can be determined based at least in part on one or more features of an anchor category of the anchor item. The method additionally can include determining a personalized recommendation strategy for the user based at least in part on a user mode for the user and the anchor label. The method further can include re-ranking the item recommendations based at least in part on the personalized recommendation strategy. The method also can include transmitting the item recommendations re-ranked to be displayed with the anchor item on the user interface. Other embodiments are disclosed.

### CROSS-REFERENCE TO RELATED APPLICATIONS

This application is a continuation in part of application Ser. No. 17/163,216, filed Jan. 29, 2021, which is herein incorporated by this reference in its entirety.

### TECHNICAL FIELD

This disclosure relates generally to a system and/or method for personalizing item recommendations.

### BACKGROUND

Providing item recommendations is a popular technique in e-commerce to make it easier for customers to explore similar items and also to boost sales of complementary items. However, existing recommender systems fail to identify a user's purpose of viewing an anchor item and to present item recommendations for the anchor item accordingly. It thus can be desired to have a system and/or method for determining a personalized item recommendation strategy according to the user's purpose and the anchor item.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for determining a personalized item recommendation strategy, according to an embodiment;

FIG. 4 illustrates a flow chart for a method, according to an embodiment; and

FIG. 5 illustrates a flow chart for a method, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five minutes, ten minutes, or fifteen minutes.

### DESCRIPTION OF EXAMPLES OF EMBODIMENTS

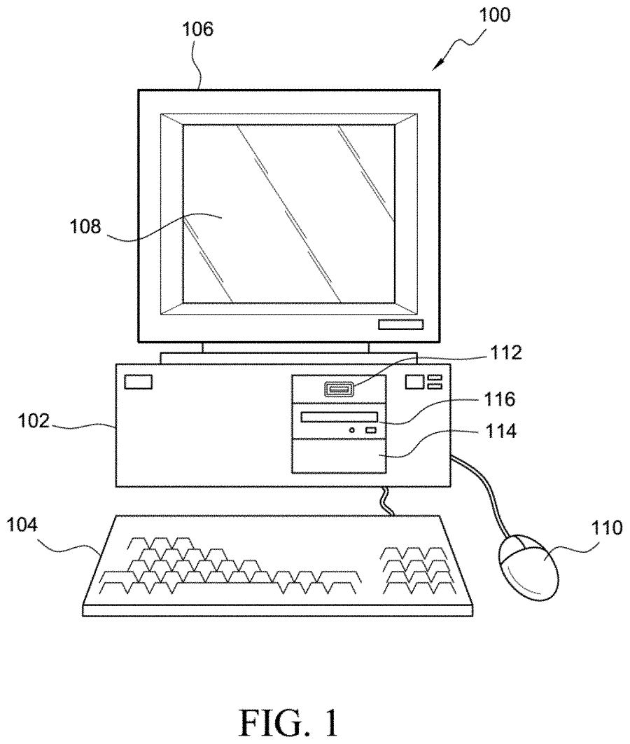

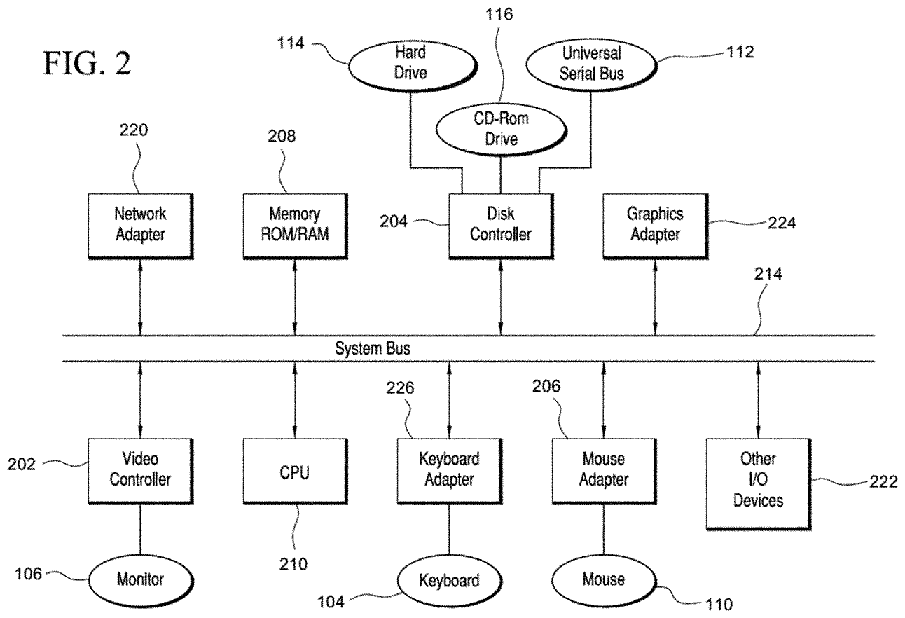

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

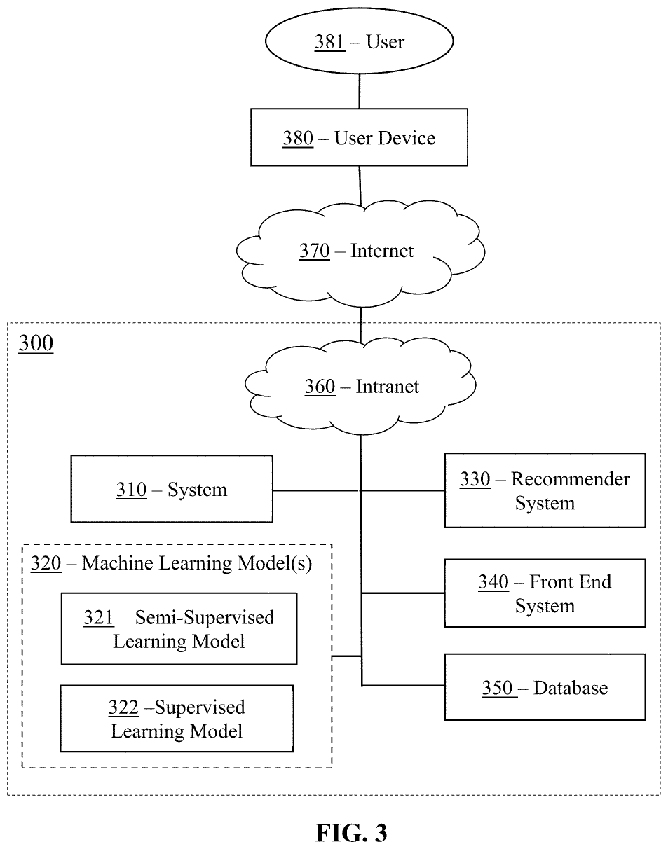

Turning ahead in the drawings, FIG. 3 illustrates a block diagram of a system 300 that can be employed for determining a personalized item recommendation strategy for an anchor item, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include a system 310, one or more machine learning models 320, a recommender system 330, a front end system 340, and/or a database 350. In many embodiments, system 300, system 310, one or more machine learning models 320, recommender system 330, and/or front end system 340 each can be modules of computing instructions (e.g., software modules) stored at non-transitory computer readable media that operate on one or more processors. In other embodiments, system 300, system 310, one or more machine learning models 320, recommender system 330, and/or front end system 340 each can be implemented in hardware. System 300, system 310, one or more machine learning models 320, recommender system 330, and/or front end system 340 each can be a computer system, such as computer system 100 (FIG. 1), as described above, and can be a single computer, a single server, or a cluster or collection of computers or servers, or a cloud of computers or servers. In another embodiment, a single computer system can host system 300, system 310, one or more machine learning models 320, recommender system 330, and/or front end system 340. In certain embodiments, system 310 can include one or more machine learning models 320, recommender system 330, and/or front end system 340. Additional details regarding system 300, system 310, one or more machine learning models 320, recommender system 330, and/or front end system 340 and the components thereof are described herein.

In some embodiments, system 300, system 310, one or more machine learning models 320, recommender system 330, and/or front end system 340 each can be in data communication directly or through Internet 370 with one or more user computers, such as user device 380. In some embodiments, user device 380 can be used by users, such as a user 381. In many embodiments, system 300, system 310, or front end system 340 can host one or more websites and/or mobile application servers. For example, front end system 340 can host a website, or provide a server that interfaces with a mobile application on user device 380, which can allow user 381 to browse and/or search for items (e.g., products, grocery items), to add items to an electronic cart, to purchase items, and/or request grocery delivery, in addition to other suitable activities.

In certain embodiments, user computers (e.g., user device 380) can be desktop computers, laptop computers, a mobile device, and/or other endpoint devices used by users (e.g., user 381). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa. In specific examples, a wearable user computer device can include a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can include (i) Google Glass™ product or a similar product by Google Inc. of Menlo Park, Calif., United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, N.Y., United States of America. In other specific examples, a head mountable wearable user computer device can include the Virtual Retinal Display™ product, or similar product by the University of Washington of Seattle, Wash., United States of America. Meanwhile, in further specific examples, a limb mountable wearable user computer device can include the iWatch™ product, or similar product by Apple Inc. of Cupertino, Calif., United States of America, the Galaxy Gear or similar product of Samsung Group of Samsung Town, Seoul, South Korea, the Moto 360 product or similar product of Motorola of Schaumburg, Ill., United States of America, and/or the Zip™ product, One™ product, Flex™ product, Charge™ product, Surge™ product, or similar product by Fitbit Inc. of San Francisco, Calif., United States of America.

In many embodiments, system 300, system 310, one or more machine learning models 320, recommender system 330, and/or front end system 340 each can include one or more input devices (e.g., one or more keyboards, one or more keypads, one or more pointing devices such as a computer mouse or computer mice, one or more touchscreen displays, a microphone, etc.), and/or can include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 300, system 310, one or more machine learning models 320, recommender system 330, and/or front end system 340 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 300, system 310, one or more machine learning models 320, recommender system 330, and/or front end system 340. In a similar manner, the processors and/or the non-transitory computer-readable media can be local and/or remote to each other.

Meanwhile, in many embodiments, system 300, system 310, one or more machine learning models 320, recommender system 330, and/or front end system 340 also can be configured to communicate with and/or include one or more databases, such database 350, and/or other suitable databases. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Still referring to FIG. 3, system 300, system 310, one or more machine learning models 320, recommender system 330, front end system 340, and/or database 350 can be in data communication with each other directly or via any suitable computer network, including Internet 370 or an internal network that is not open to the public (e.g., Intranet 360). Communication between system 300, system 310, one or more machine learning models 320, recommender system 330, front end system 340, and/or database 350 can be implemented using any suitable manner of wired and/or wireless communication. Accordingly, system 300 can include any software and/or hardware components configured to implement the wired and/or wireless communication.

Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

Meanwhile, in many embodiments, one or more machine learning models 320 can include a semi-supervised learning model 321 and/or a supervised learning model 322. In many embodiments, one or more machine learning models 320 each can be implemented by any suitable software components, hardware components, and/or various combinations thereof, of system 300. For example, in some embodiments, one or more machine learning models 320 each can adopt any suitable algorithms, such as decision tree, logistic regression, random forest, support vector machines, clustering, and so forth. In some embodiments, one or more machine learning models 320 each can be implemented through any suitable software development platforms or open source software packages, such as, TensorFlow, Theano, PyTorch, PySpark, or Scikit-learn, and written in any suitable languages, such as Python, C++, and/or CUDA.

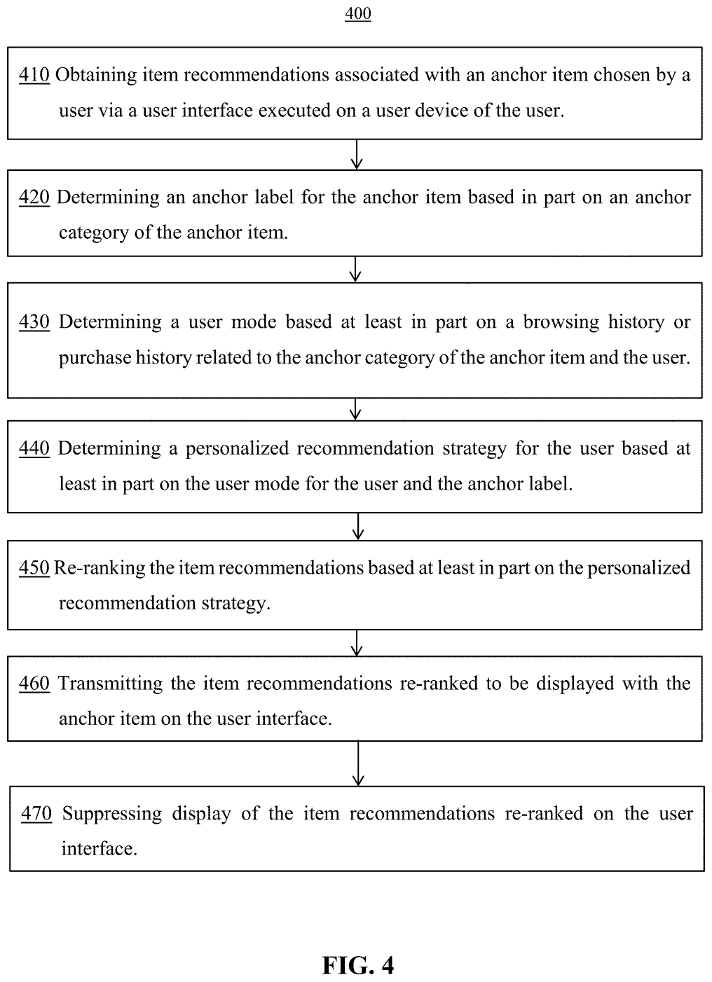

Turning ahead in the drawings, FIG. 4 illustrates a flow chart for a method 400 of determining a personalized item recommendation strategy based at least in part on a user mode of a user and an anchor label for an anchor item and presenting item recommendations to the user accordingly. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3) or system 310 (FIG. 3) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1).

In some embodiments, method 400 and other blocks in method 400 can include using a distributed network including distributed memory architecture to perform the associated activity. This distributed architecture can reduce the impact on the network and system resources to reduce congestion in bottlenecks while still allowing data to be accessible from a central location.

Referring to FIG. 4, method 400 can include a block 410 of obtaining item recommendations associated with an anchor item chosen by a user via a user interface executed on a user device of the user. In many embodiments, the item recommendations can be received from a recommender system (e.g., system 310 (FIG. 3) or recommender system 330 (FIG. 3)) via a computer network (e.g., Intranet 360 (FIG. 3) or Internet 370 (FIG. 3)). In some embodiments, each of the item recommendations can be an item group or item carousel that includes one or more respective recommended items. In certain embodiments, each of the item recommendations can be associated with a respective recommendation basis. Examples of item recommendations associated with various respective recommendation bases can include personalized similarity-based recommendations (e.g., an item recommendation called “Similar items you might like”), personalized complementary-based recommendations (e.g., an item recommendation called “Recommended for you” or “Selected items for you”), common similarity-based recommendations (e.g., an item recommendation called “Customers ended up buying” or “Popular items in this category”), and common complementary-based recommendations (e.g., an item recommendation called “Customers also bought these products” or “Complementary items”), etc.

In a number of embodiments, method 400 further can include a block 420 of determining an anchor label for the anchor item based at least in part on an anchor category of the anchor item. In many embodiments, the anchor label for the anchor item can be upsell or cross-sell. In some embodiments, one or more categories can include the anchor category, and each of the one or more categories can be associated with a single respective label (e.g., upsell or cross-sell, but not both). Examples of categories with an upsell label (i.e., upsell categories) can include: fresh & frozen vegetables, juices, cheeses, packaged meals, video games, over-the-counter medicines, board games, books, and/or movies, etc. Examples of categories with a cross-sell label (i.e., cross-sell categories) can include televisions, vacuum cleaners, air fryer, cell phones, exercise bikes, and/or mattresses, etc.

In many embodiments, each of the one or more categories can include one or more respective features. In some embodiments, block 420 can determine the one or more respective features of each of the one or more categories based at least in part on one or more item attributes (e.g., product descriptions, images, brands, etc.) of items within the each of the one or more categories. In similar or different embodiments, block 420 additionally can determine the one or more respective features of each of the one or more categories based at least in part on historical transactions associated with the each of the one or more categories during a period of time (e.g., 3 months, 5 months, 1 year, 2 years, or any other suitable periods of time). Examples of the one or more respective features of a category based on historical transactions can include one or more of: (a) a number of customers that bought at least 2 items from the category in the same transaction; (b) a number of items in the category that are part of the transactions in (a), and/or (c) a ratio of customers who bought at least 2 items from the category to customers who bought any item from the category.

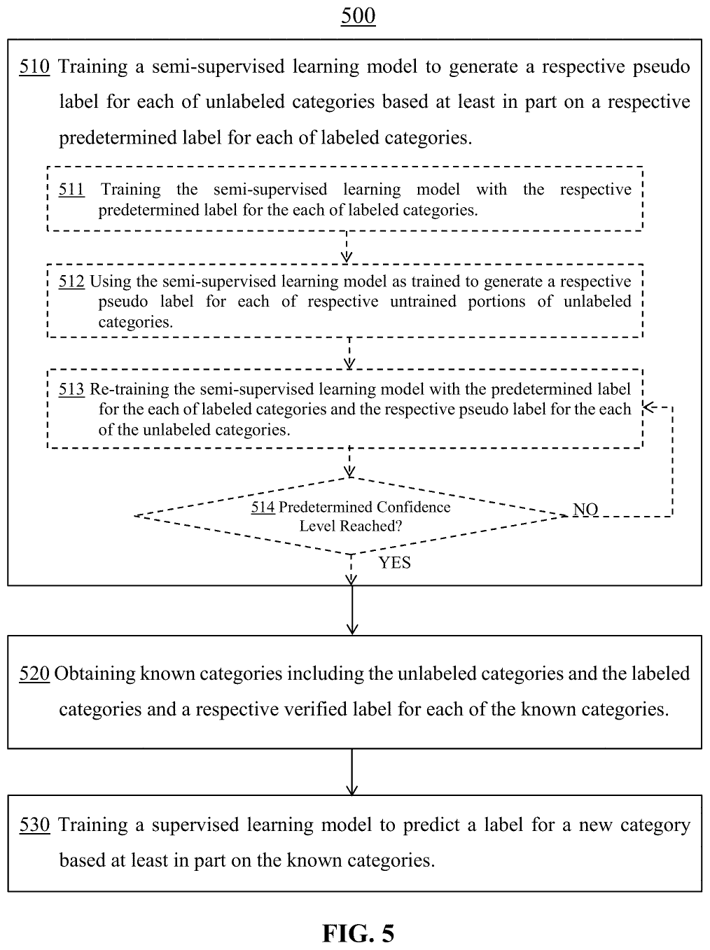

In a number of embodiments, block 420 can determine the anchor label for the anchor item by a pre-trained machine learning model. In several embodiments, the pre-trained machine learning model can be trained offline based at least in part on historical input data (e.g., historical transactions during a predetermined period of time, and/or one or more respective features of each of the one or more categories, etc.) and historical output data (e.g., a respective verified label for the each of the one or more categories). In many embodiments, the pre-trained machine learning model can include one or more machine learning models (e.g., one or more machine learning models 320 (FIG. 3), semi-supervised learning model 321 (FIG. 3), and/or supervised learning model 322 (FIG. 3)) that can be trained in any suitable manner, such as method 500 (FIG. 5) as described below.

Turning ahead in the drawings, FIG. 5 illustrates a flow chart for a method 500 of training one or more machine learning models to determine a label for an item category, according to an embodiment. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, system 300 (FIG. 3), system 310 (FIG. 3), one or more machine learning models 320 (FIG. 3), semi-supervised learning model 321 (FIG. 3), and/or supervised learning model 322 (FIG. 3) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of a computer system such as system 300 (FIG. 3). The processor(s) can be similar or identical to the processor(s) described above with respect to computer system 100 (FIG. 1).

In some embodiments, method 500 and other blocks in method 500 can include using a distributed network including distributed memory architecture to perform the associated activity. This distributed architecture can reduce the impact on the network and system resources to reduce congestion in bottlenecks while still allowing data to be accessible from a central location.

Referring to FIG. 5, method 500 can include a block 510 of training a semi-supervised learning model (e.g., semi-supervised learning model 321 (FIG. 3)) to generate a respective pseudo label for each of unlabeled categories based at least in part on a respective predetermined label for each of labeled categories. In certain embodiments, the labeled categories can include fewer, an equal number of, or more categories than the unlabeled categories. For example, a ratio of the labeled categories to the unlabeled categories can be 1:3, 1:10, 1:15, 1:30, or another suitable ratio. In a number of embodiments, block 510 can include training the semi-supervised learning model iteratively to generate the respective pseudo label for the each of the unlabeled categories until a predetermined confidence level is reached, based at least in part on historical input data, historical output data, and/or one or more respective features of each of the unlabeled categories. The historical input data can comprise one or more respective features of each of labeled categories, and/or historical transactions during a predetermined time period, such as 3 months, 6 months, a year, or another suitable time periods. The historical output data can include the respective predetermined label for each of the labeled categories.

In many embodiments, block 510 further or alternatively can include training the semi-supervised learning model iteratively to generate the respective pseudo label for each of respective untrained portions of the unlabeled categories. The historical input data can include one or more respective features of each of labeled categories, historical transactions during the predetermined time period; and/or the one or more respective features of each of respective trained portions of the unlabeled categories. The historical output data can include a respective predetermined label for each of the labeled categories and/or the respective pseudo label for each of the respective trained portions of the unlabeled categories. The unlabeled categories can be divided into any suitable number of untrained portions (e.g., 2, 3, 5, or 10), and the untrained portions can be of the same or different sizes.

In a number of embodiments, block 510 can further include a block 511 of training the semi-supervised learning model with the respective predetermined label for the each of labeled categories. In some embodiments, an operator or administrator can provide the respective predetermined label for the each of the labeled categories by one or more input device(s) (e.g., keyboard 104 (FIG. 1) and/or mouse 110 (FIG. 1)) and one or more display device(s) (e.g., monitor 106 (FIG. 1) and/or screen 108 (FIG. 1)) coupled to the semi-supervised learning model (e.g., semi-supervised learning models 321 (FIG. 3)) or via a user interface executed on a user computer (e.g., user device 380 (FIG. 3) or computer system 100 (FIG. 1)) communicating with semi-supervised learning model directly or through a computer network (e.g., Intranet 360 (FIG. 3) or Internet 370 (FIG. 3)).

In a number of embodiments, block 510 can further include a block 512 of using the semi-supervised learning model as trained to generate a respective pseudo label for each of respective untrained portions of unlabeled categories. In many embodiments where the unlabeled categories can be divided into at least 3 portions, block 512 can include: (a) using the semi-supervised learning model as trained in block 511 to generate the respective pseudo label for each of a first untrained portion (e.g., the first 10%, 20%, 30%, or 50% of categories) of the unlabeled categories; (b) retraining the semi-supervised learning model as trained in block 511 with the respective predetermined label for the each of the labeled categories and the respective pseudo label for the each of the first untrained portion generated in part (a); (c) using the semi-supervised learning model as trained in part (b) to generate the respective pseudo label for each of a second untrained portion of the unlabeled categories; (d) retraining the semi-supervised learning model as trained in part (b) with the respective predetermined label for the each of labeled categories, the respective pseudo label for the each of the first untrained portion generated in part (a), and the respective pseudo label for the each of the second untrained portion generated in part (c); (e) using the semi-supervised learning model as trained in part (d) to generate the respective pseudo label for a third untrained portion of the unlabeled categories, and so forth, until there are no untrained portions of the unlabeled categories.

In some embodiments, block 510 can further include a block 513 of re-training the semi-supervised learning model with the predetermined label for the each of labeled categories and the respective pseudo label for the each of the unlabeled categories. In many embodiments, block 513 can include procedures, processes, and/or activities similar or identical to some or all of the procedures, processes, and/or activities of block 511 and/or block 512.

In several embodiments, block 510 can further include a block 514 of determining whether a predetermined confidence level (e.g., 80%, 85%, 90%, 95%, 99%, etc.) is reached. If the confidence level for the pseudo label data is not at least as great as the predetermined confidence level, block 510 can repeat by going back to block 513 to further train the semi-supervised learning model. In some embodiments, block 510 can repeat blocks 511, 512, and/or 513 until reaching the predetermined confidence level.

In a number of embodiments, method 500 further can include a block 520 of obtaining known categories including the unlabeled categories and the labeled categories and a respective verified label for each of the known categories. In certain embodiments, block 520 can obtain the known categories including the unlabeled categories and the labeled categories and the respective verified label for each of the known categories from one or more databases (e.g., database 350 (FIG. 3)). In many embodiments, block 520 further can include receiving the known categories and the respective verified label for the each of the known categories from the operator or administrator via the input device(s) (e.g., keyboard 104 (FIG. 1) and/or mouse 110 (FIG. 1)) or via a computer network (e.g., Intranet 360 (FIG. 3) or Internet 370 (FIG. 3)) from the user computer (e.g., computer system 100 (FIG. 1) or user device 380 (FIG. 3)).

In a number of embodiments, method 500 additionally can include a block 530 of training a supervised learning model (e.g., supervised learning model 322 (FIG. 3)) to predict a label for a new category based at least in part on the known categories. In many embodiments, block 530 can train the supervised learning model to predict the label for the new category further based at least in part on historical input data and/or historical output data, etc. The historical input data can include one or more respective features of each of the known categories, and/or the historical transactions during a predetermined time period (e.g., 1 month, 3 months, 6 months, a year, or any other suitable time periods). The historical output data can comprise the respective verified label for each of the known categories obtained in block 520. In some embodiments, block 530 can use the supervised learning model to predict the label for the new category by one or more of: (a) training the supervised learning model based at least in part on the historical input data and/or the historical output data; (b) obtaining the one or more respective features of the new category based at least in part on items in the new category and/or the historical transactions; and/or (c) using the supervised learning model to determine the label for the new category based at least in part on the one or more respective features of the new category.

Referring back to FIG. 4, in a number of embodiments, method 400 further can include a block 430 of determining a user mode of the user (e.g., user 381 (FIG. 3)) based at least in part on a browsing history and/or purchase history related to the anchor category of the anchor item and the user. In many embodiments, the user mode can be discovery or repurchase. In some embodiments, block 430 can determine that the user mode is discovery when the browsing history of the user shows that the user has been viewing the anchor item or similar items in the anchor category at least twice recently (e.g., in the past 24 hours, 2 days, 3 days, a week, or a month, etc.). In several embodiments, block 430 can determine that the user mode is repurchase when the purchase history of the user shows that the user purchased the anchor item or similar items in the anchor category recently (e.g., in the past month, 45 days, 60 days, 90 days, 6 months, etc.).

In a number of embodiments, method 400 further can include a block 440 of determining a personalized recommendation strategy for the user (e.g., user 381 (FIG. 3)) based at least in part on the user mode for the user determined in block 430 and the anchor label determined in block 420. In many embodiments, block 440 can determine that: (a) the personalized recommendation strategy is upsell when the user mode is discovery and the anchor label is upsell; and/or (b) the personalized recommendation strategy is cross-sell when the user mode is repurchase and the anchor label is cross-sell. In similar or other embodiments, block 440 also can determine that when neither of the aforementioned conditions exists, the personalized recommendation strategy can be a default recommendation strategy (e.g., no re-ranking) or a priced based recommendation strategy (e.g., re-ranking based on item prices).

In a number of embodiments, method 400 additionally can include a block 450 of re-ranking the item recommendations based at least in part on the personalized recommendation strategy. In many embodiments, block 450 further can include, when the personalized recommendation is upsell (e.g., when the user mode is discovery and the anchor label is upsell), giving at least one similar recommendation of the item recommendations a high ranking; and/or, when the personalized recommendation is cross-sell (e.g., when the user mode is repurchase, and the anchor label is cross-sell), giving at least one complimentary recommendation of the item recommendations the high ranking. In some embodiments, a high ranking can refer to top 1, top 3, top 10, or top 50%, etc., among the item recommendations. In other or similar embodiments, a high ranking can refer to an improved ranking than the original ranking for an item (e.g., changing the ranking from N to N−1 or N−2, etc.).

In certain embodiments, block 450 additionally can include re-ranking the item recommendations further based at least in part on the respective recommendation basis for each of the item recommendations. For example, in embodiments where each of the item recommendations is associated with a respective recommendation basis, when the personalized recommendation strategy determined in block 440 is upsell, block 450 can re-rank the item recommendations by moving at least one recommendation whose respective recommendation basis is similarity-based (e.g., personalized similarity-based or common similarity-based) to the top 10% or at least one ranking higher than its original ranking, if possible, among the item recommendations. In similar or other embodiments, when the personalized recommendation strategy determined is cross-sell, block 450 can re-rank the item recommendations by moving at least one recommendation whose respective recommendation basis is complementary-based (e.g., personalized complementary-based or common complementary-based) to at least the top 30%, among the item recommendations.

In a number of embodiments, method 400 further can include block 460 of transmitting the item recommendations re-ranked to be displayed with the anchor item on the user interface. In some embodiments, block 460 can transmit, directly or indirectly through the computer network (e.g., Internet 370 (FIG. 3)), the item recommendations re-ranked in block 450 to be displayed with the anchor item on the user interface executed on the user device (e.g., user device 380 (FIG. 3)) of the user (e.g., user 381 (FIG. 3)).

In many embodiments, method 400 can further include block 470 of suppressing display of the item recommendations re-ranked on the user interface. In these or other embodiments, activity 407 can be performed in response to a purchase, add to cart, and/or view of an item (e.g., an anchor item and/or a recommended item). In various embodiments, a suppressed item recommendation can be prevented from being displayed on the user interface even when it is determined to be a recommendation for an anchor item. In some embodiments, all items in a category of items can be suppressed. In these or other embodiments, only a specific item can be suppressed. For example, when a recommendation is for a cross-sell item, an item can be suppressed at the category level, and when a recommendation is for an up-sell item, only the specific recommended item can be suppressed. In this way, a user can be prevented from being shown substitutes (e.g., showing cross sell items in lieu of similar items) for items that were purchased while at the same time showing the user other items frequently bought with an anchor item.

Item suppression can last for a suppression duration after it begins. In various embodiments, a suppression duration can be set by an administrator and/or automatically determined via one or more sets of rules without human interaction. In some embodiments, a suppression duration can be determined via a plurality of sets of rules and a shortest duration can be chosen. In many embodiments, a set of rules can be determined using data for a top 10% of purchasers globally and/or for a category of an item. In this way, outliers (e.g., users who have made only one purchase) can be prevented from skewing a length of a suppression duration. In some embodiments, a first set of rules can comprise setting a suppression duration to be equal to one or more of an average time between purchases for a suppressed item and/or a maximum time between purchases for a suppressed item. In these embodiments, purchases can be removed from consideration when they are returned, canceled, and/or bulk purchases. In this way, outlier influence on the suppression duration can be minimized. In various embodiments, a predictive algorithm can be used to set a suppression duration. For example, a suppression duration can be determined using a conditional probability of a user making a purchase during time interval t when the user did not make a purchase during time interval (0, t). In some embodiments, a regression analysis can be used to predict a suppression duration. For example, a hazard regression can be used to model a suppression duration based on general historical data or historical data specific to the user. In these other embodiments, a suppression duration can be modeled as a time series that is optimized for one or more metrics. For example, a time series can be optimized for shortest duration, largest number of sales, most user interactions, etc.

In many embodiments, the techniques described herein can provide several technological improvements. In many embodiments, the techniques described herein can improve the personalization of item recommendations by automatically determining a personalized item recommendation strategy based in part on the anchor category of the anchor item and the user mode for the user in real-time. In addition, in some embodiments, the techniques described herein can improve the personalization of item recommendations by using a machine learning model to automatically identify the nature of each item category based at least in part on item attributes and transaction histories for the each item category and label the each item category accordingly.

In many embodiments, the techniques described herein can be used continuously at a scale that cannot be handled using manual techniques. For example, the number of users concurrently browsing or searching items on an e-commerce site can be at least hundreds or thousands, and the automatic determination of the personalized item recommendation strategy and the re-ranking of the item recommendations accordingly for the hundreds or thousands of users cannot be handled manually in real-time.

In a number of embodiments, the techniques described herein can solve a technical problem that arises only within the realm of computer networks, as e-commerce does not exist outside the realm of computer networks. Moreover, the techniques described herein can solve a technical problem that cannot be solved outside the context of computer networks. Specifically, the techniques described herein cannot be used outside the context of computer networks, in view of a lack of data and because the machine learning models cannot be performed without a computer.

Various embodiments can include a system including one or more processors and one or more non-transitory computer-readable media storing computing instructions configured to run on the one more processors and perform certain acts. The acts can include obtaining item recommendations associated with an anchor item chosen by a user via a user interface executed on a user device of the user. The acts further can include determining an anchor label for the anchor item. In some embodiments, the anchor label can be determined based at least in part on one or more features of an anchor category of the anchor item. The acts additionally can include determining a personalized recommendation strategy for the user based at least in part on a user mode for the user and the anchor label. The acts also can include re-ranking the item recommendations based at least in part on the personalized recommendation strategy. The acts further can include transmitting the item recommendations re-ranked to be displayed with the anchor item on the user interface.

A number of embodiments can include a method being implemented via execution of computing instructions configured to run at one or more processors and stored at one or more non-transitory computer-readable media. The method can include obtaining item recommendations associated with an anchor item chosen by a user via a user interface executed on a user device of the user. The method further can include determining an anchor label for the anchor item. In a number of embodiments, the anchor label can be determined based at least in part on one or more features of an anchor category of the anchor item. The method additionally can include determining a personalized recommendation strategy for the user based at least in part on a user mode for the user and the anchor label. The method further can include re-ranking the item recommendations based at least in part on the personalized recommendation strategy. The method also can include transmitting the item recommendations re-ranked to be displayed with the anchor item on the user interface.

Although determining a personalized recommendation strategy and re-ranking item recommendations based at least in part on the personalized recommendation strategy has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIGS. 4 and/or 5 may include different procedures, processes, and/or activities and be performed by many different modules, in many different orders, and/or one or more of the procedures, processes, or activities of FIGS. 4 and/or 5 may include one or more of the procedures, processes, or activities of another different one of FIGS. 4 and/or 5. As another example, the elements, modules, or systems within system 300 in FIG. 3, system 310 in FIG. 3, one or more machine learning models 320 in FIG. 3, recommender system 330 in FIG. 3, and/or front end system 340 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions configured to run on the one or more processors and causing the one or processors to perform functions comprising:
obtaining item recommendations associated with an anchor item chosen by a user via a user interface executed on a user device of the user;
determining an anchor label for the anchor item, wherein:
the anchor label is determined based at least in part on one or more features of an anchor category of the anchor item;
determining a personalized recommendation strategy for the user based at least in part on a user mode for the user and the anchor label;
re-ranking the item recommendations based at least in part on the personalized recommendation strategy; and
transmitting the item recommendations re-ranked to be displayed with the anchor item on the user interface.

2. The system in claim 1, wherein:
each of the item recommendations further comprises one or more respective recommended items; and
the each of the item recommendations is associated with a respective recommendation basis.

3. The system in claim 2, wherein:
re-ranking the item recommendations further comprises re-ranking the item recommendations further based at least in part on the respective recommendation basis for each of the item recommendations.

4. The system in claim 2, wherein:
the user mode is one of discovery or repurchase;
the anchor label is one of upsell or cross-sell; and
re-ranking the item recommendations further comprises:
when the user mode is discovery and when the anchor label is upsell, giving at least one similar recommendation of the item recommendations a high ranking; and
when the user mode is repurchase and when the anchor label is cross-sell, giving at least one complimentary recommendation of the item recommendations the high ranking.

5. The system in claim 1, wherein:
the computing instructions are further configured to cause the one or more processors to perform additional functions comprising:
determining the user mode based at least in part on a browsing history or a purchase history related to the anchor category and the user.

6. The system in claim 1, wherein:
the anchor label is determined by a machine learning model; and
the machine learning model comprises a semi-supervised learning model and a supervised learning model.

7. The system in claim 6, wherein:
the computing instructions are further configured to cause the one or more processors to perform additional functions comprising:
training the semi-supervised learning model to generate a respective pseudo label for each of unlabeled categories based at least in part on a respective predetermined label for each of labeled categories;
obtaining known categories and a respective verified label for each of the known categories, wherein:
the known categories comprise the unlabeled categories and the labeled categories; and
training the supervised learning model to predict a label for a new category based at least in part on the known categories.

8. The system in claim 6, wherein:
the computing instructions are further configured to cause the one or more processors to perform additional functions comprising:
training the semi-supervised learning model to generate a respective pseudo label for each of unlabeled categories until a predetermined confidence level is reached, based at least in part on:
historical input data comprising:
one or more respective features of each of labeled categories; and;
historical transactions during a predetermined time period;
historical output data comprising a respective predetermined label for each of the labeled categories; and
one or more respective features of each of the unlabeled categories.

9. The system in claim 8, wherein:
training the semi-supervised learning model to generate the respective pseudo label for each of the unlabeled categories further comprises:
training the semi-supervised learning model iteratively to generate the respective pseudo label for each of respective untrained portions of the unlabeled categories, wherein:
the historical input data further comprises the one or more respective features of each of respective trained portions of the unlabeled categories; and
the historical output data further comprises the respective pseudo label for each of the respective trained portions of the unlabeled categories.

10. The system in claim 6, wherein:
the computing instructions are further configured to cause the one or more processors to perform additional functions comprising:
training the supervised learning model to predict a label for a new category, based on:
historical input data comprising:
one or more respective features of each of known categories; and;
historical transactions during a predetermined time period; and
historical output data comprising a respective verified label for each of the known categories.

11. A method being implemented via execution of computing instructions configured to run at one or more processors and stored at one or more non-transitory computer-readable media, the method comprising:
obtaining item recommendations associated with an anchor item chosen by a user via a user interface executed on a user device of the user;
determining an anchor label for the anchor item, wherein:
the anchor label is determined based at least in part on one or more features of an anchor category of the anchor item;
determining a personalized recommendation strategy for the user based at least in part on a user mode for the user and the anchor label;
re-ranking the item recommendations based at least in part on the personalized recommendation strategy; and
transmitting the item recommendations re-ranked to be displayed with the anchor item on the user interface.

12. The method in claim 11, wherein:
each of the item recommendations further comprises one or more respective recommended items; and
the each of the item recommendations is associated with a respective recommendation basis.

13. The method in claim 12, wherein:
re-ranking the item recommendations further comprises re-ranking the item recommendations further based at least in part on the respective recommendation basis for each of the item recommendations.

14. The method in claim 12, wherein:
the user mode is one of discovery or repurchase;
the anchor label is one of upsell or cross-sell; and
re-ranking the item recommendations further comprises:
when the user mode is discovery and when the anchor label is upsell, giving at least one similar recommendation of the item recommendations a high ranking; and
when the user mode is repurchase and when the anchor label is cross-sell, giving at least one complimentary recommendation of the item recommendations the high ranking.

15. The method in claim 11, further comprising:
determining the user mode based at least in part on a browsing history or a purchase history related to the anchor category and the user.

16. The method in claim 11, wherein:
the anchor label is determined by a machine learning model; and
the machine learning model comprises a semi-supervised learning model and a supervised learning model.

17. The method in claim 16, further comprising:
training the semi-supervised learning model to generate a respective pseudo label for each of unlabeled categories based at least in part on a respective predetermined label for each of labeled categories;
obtaining known categories and a respective verified label for each of the known categories, wherein:
the known categories comprise the unlabeled categories and the labeled categories; and
training the supervised learning model to predict a label for a new category based at least in part on the known categories.

18. The method in claim 16, further comprising:
training the semi-supervised learning model to generate a respective pseudo label for each of unlabeled categories until a predetermined confidence level is reached, based at least in part on:
historical input data comprising:
one or more respective features of each of labeled categories; and;
historical transactions during a predetermined time period;
historical output data comprising a respective predetermined label for each of the labeled categories; and
one or more respective features of each of the unlabeled categories.

19. The method in claim 18, wherein:
training the semi-supervised learning model to generate the respective pseudo label for each of the unlabeled categories further comprises:
training the semi-supervised learning model iteratively to generate the respective pseudo label for each of respective untrained portions of the unlabeled categories, wherein:
the historical input data further comprises the one or more respective features of each of respective trained portions of the unlabeled categories; and
the historical output data further comprises the respective pseudo label for each of the respective trained portions of the unlabeled categories.

20. The method in claim 16, further comprising:
training the supervised learning model to predict a label for a new category, based on:
historical input data comprising:
one or more respective features of each of known categories; and;
historical transactions during a predetermined time period; and
historical output data comprising a respective verified label for each of the known categories.
